(19) United States
(12) Patent Application Publication
(10) Pub. No.: US 2005/0015441 A1
(43) Pub. Date: Jan. 20, 2005

(54) Distributed event notification system

(76) Inventors: Daren William Attwood, Ashburton (AU); Timothy Edmund Hastings, Oakleigh (AU)

Correspondence Address: BIRCH STEWART KOLASCH & BIRCH, PO BOX 747, FALLS CHURCH, VA, 22040-0747, US

(21) Appl. No.: 10/742,876

(22) Filed: Dec. 23, 2003

Related U.S. Application Data
(63) Continuation of application No. PCT/IB02/03405, filed on Jun. 27, 2002.
(60) Provisional application No. 60/301,463, filed on Jun. 27, 2001.

(51) Int. Cl. G06F 12/00; G06F 15/16

(52) U.S. Cl. 709/203; 707/201

(57) ABSTRACT

This invention provides a software solution for synchronizing distributed computer software applications and components that share information. Each distributed computer software application is notified of relevant changes to shared information in an efficient and timely manner. Such software applications register interest in the actions performed on data objects, to notify other software applications of actions performed, and to receive notification events of the actions performed by other software applications which have a registered interest in common data objects. The distributed event notification system of the present invention provides a lightweight solution that does not require on specific distributed software architectures or frameworks. The software applications need only support a small software interface that imposes very little overhead in terms of computing resources, performance and network bandwidth.

### FIELD OF THE INVENTION

The present invention relates to the field of computerized data handling. In particular, the present invention relates to a method and mechanism which allows distributed software applications to remain in synchronization with the current state of a system of data objects. For example, a set of related medical applications distributed across a hospital network may register interest in changes to all patients or a specific set of patients so that up to date patient information is always available to and used by all software applications of the hospital. The distributed event notification system allows each specific network node (or location in a hospital) to work independently yet access and change up to date information at other nodes (or remote locations).

### BACKGROUND OF THE PRESENT INVENTION

Several data handling and data synchronization systems have been developed and/or patented or described in various publications. For example, U.S. Pat. Nos. 5,592,664; 5,133,075; 5,826,253; 5,768,511; 5,367,633; 5,315,703; 5,606,493 and 5,887,172 represent a reasonable cross section of some similar techniques and/or architectures for data handling and/or data synchronization systems. These references as illustrative and in no manner as a comprehensive listing of all related art.

### SUMMARY OF THE PRESENT INVENTION

This invention provides a software solution for synchronizing distributed computer software applications and components that share information through a distributed event notification system. The notification system ensures that each distributed computer software application is notified of relevant changes to shared information in an efficient and timely manner. The notification system enables software applications to register interest in the actions performed on data objects, to notify other software applications of actions performed, and to receive notification events of the actions performed by other software applications which have a registered interest in common data objects.

The distributed event notification system of the present invention provides a lightweight solution that does not require specific distributed software architectures or frameworks such as CORBA or Microsoft DNA 2000 which require large software infrastructures, significant computing resources and impose large and complicated interfaces on applications and components. In accordance with the present invention, software applications need only support a small software interface that imposes very little overhead in terms of computing resources, performance and network bandwidth.

The distributed event notification system of the present invention allows distributed software applications to remain in synchronization with the current state of a system of data objects. For example, a set of related medical applications distributed across a hospital network may register interest in changes to all patients or a specific set of patients so that up to date patient information is always available to and used by all software applications of the hospital. The distributed event notification system allows each specific network node (or location in a hospital) to work independently yet access and change up to date information at other nodes (or remote locations).

The notification system of the present invention may also be used to synchronize multiple sources of information. For example, appointments may be independently maintained at two or more locations—each on a separate machine. A set of applications may register interest in changes to appointments at all locations via a common Data Sync Service. When a change is made to appointments at any of the locations in questions, then all interested applications will be notified of the change. The distributed event notification system of the present invention allows each location to work independently yet access and change information at remote locations.

### DESCRIPTION OF THE DRAWINGS

FIG. 1 illustrates one embodiment of the distributed event notification service architecture of the present invention in a client/server environment.

FIG. 2 illustrates one embodiment of the life cycle of a Data Sync Service.

FIG. 3 illustrates examples of typical sequences of interactions between applications (or components) and a server.

FIG. 4 illustrates examples of applications (or components) that are interested in changes to objects on multiple servers using a common Data Sync Server that may be located on any machine.

### DETAILED DESCRIPTION OF THE PREFERRED EMBODIMENTS OF THE PRESENT INVENTION

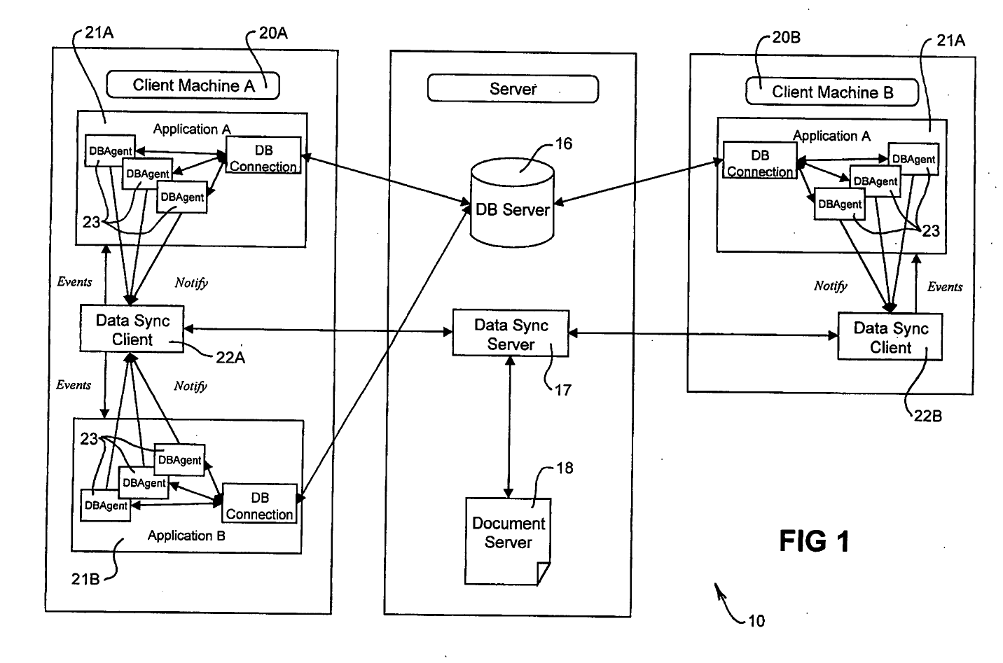

FIG. 1 illustrates one embodiment of the Distributed Event Notification Service architecture 10 of the present invention in a client/server environment. In this embodiment, a distributed system 10 consists of one or more server machines 15 and one or more client machines, such as 20A and 20B. In FIG. 1, the server manages a Database Server 16, a Data Sync Server 17 and a Document Server 18. Client machines 20A and 20B manage applications 21A and 21B that access the database and documents on the server machine 15. A Data Sync Client 22A or 22B provides services to client applications 21A or 21B, respectively, that attach and register interest in specified object types, objects and actions. Client applications 21A and 21B access database objects via agents 23 that notify the Data Sync Server 17 (via the local Data Sync Client 22A or 22B) of the details of the actions performed. Client applications 21A and 21B may also access documents via the Document Server 18 which notifies the Data Sync Server 17 of the actions performed. Client applications 21A and 21B are notified of changes to database objects and documents (to which interest has been registered) via a local Data Sync Client 22A and 22B, respectively. The Data Sync Server 17 manages registered applications and components and sends and receives notifications to and from each client's Data Sync Client 22A or 22B.

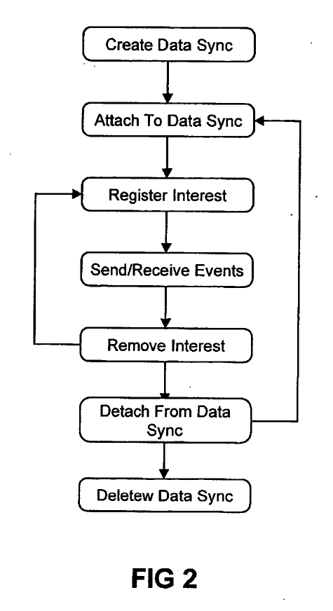

FIG. 2 illustrates one embodiment of the life cycle of a Data Sync Service. Initialization is performed by creating a Data Sync Client, such as 22A in FIG. 1, that connects to a Data Sync Server 17 as specified by a destination. Client applications and components then attach event handlers to the Data Sync Service and register interest in object types, objects and actions. Applications and components may then send notifications of actions made to objects and receive asynchronous event notifications of those actions. An application may remove interest in object types and re-register interest in new objects and actions. When an application terminates or performs some major re-initialization, the application detaches from the Data Sync Service and deletes the local Data Sync Client.

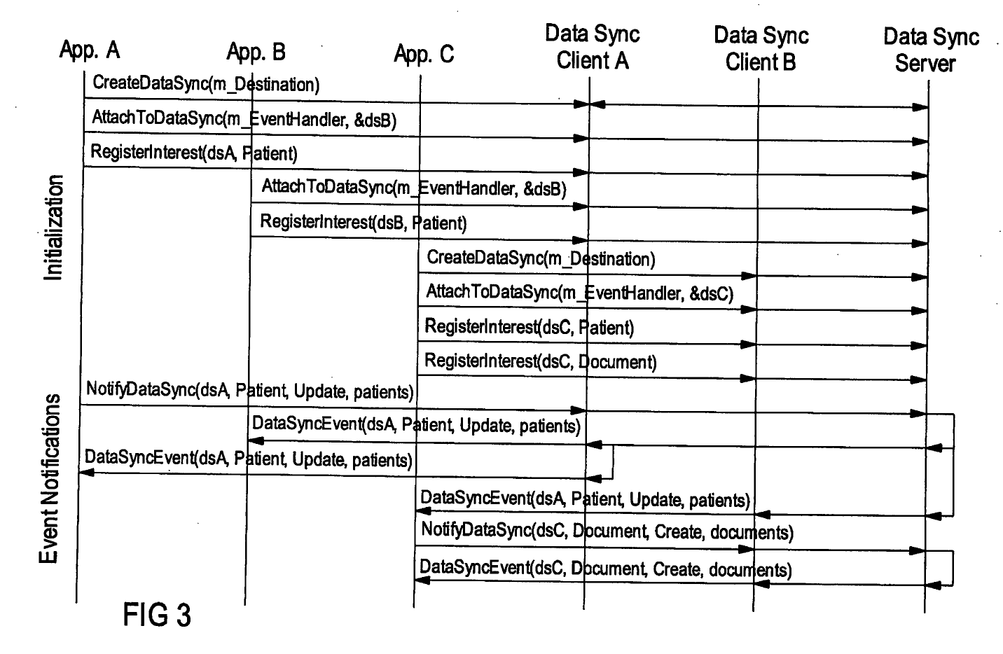

FIG. 3 illustrates examples of typical sequences of interactions between applications (or components) and a server. In FIG. 3, Application A creates a Data Sync Service on Machine A, attaches an event handler and registers interest in all operations on patients. Application B attaches to the Data Sync Service and also registers interest in all operations on patients. Application A on Machine B creates Data Sync Service on Machine B. Application B registers interest in all operations on patients and documents. All applications are interested in patient operations. Application A on Machine B is also interested in operations on documents.

When Application A on Machine A updates information associated with a specific patient, a notification is sent to the Data Sync Server. The Data Sync Server sends an asynchronous event to the Data Sync Clients on Machine A and Machine B. The respective Data Sync Clients send asynchronous events to the event handlers of all interested applications, i.e., Application A Machine A, Application B Machine A, and Application A Machine B. The event contains the source of the action (Application A Machine B), the type of the object updated (Patient), the action performed (Update) and the identity of the specific patient (objects are identified by a Globally Unique Identifier). Each application may now take appropriate action, such as redisplay the updated patient record.

When Application A on Machine B creates a new document, a notification is sent to the Data Sync Server. The Data Sync Server sends an asynchronous event to all interested application event handlers via their local Data Sync Client. In this case only Application A on Machine B is interested—the application on the machine that created the document.

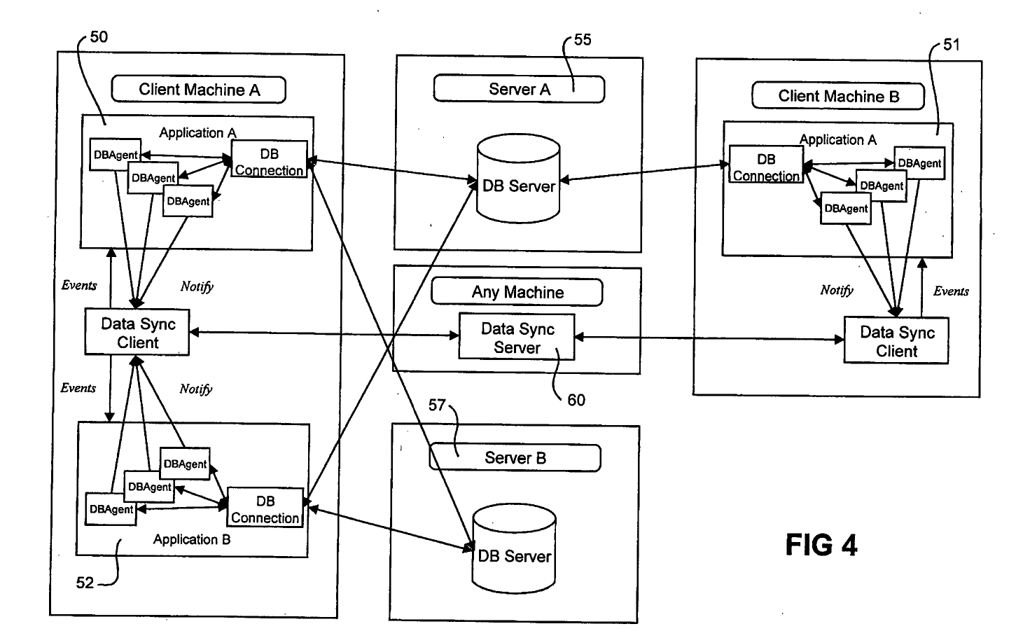

The above example illustrates how the distributed event notification system of the present invention is used in a typical client/server environment. The notification system of the present invention may also be used to synchronize different sources of information. In FIG. 4, applications 50-52 are interested in changes to objects on Server A 55 and Sewer B 57. The Data Sync Server 60 may run on a separate machine or may run on any of the machines in the network—provided all applications that register interest in notifications from that Data Sync Server can access it. When an application 50, 51 or 52 makes a change to an object of interest to either of the servers 55 or 57, then all interested applications 50-52 will be notified of the change. For example, appointments may be maintained at two or more locations—each on a separate machine. A set of applications 50-52 may register interest in changes to appointments on all locations via the common Data Sync Server 60. When a change is made to appointments at any location, then all interested applications 50-52 will be notified of the change.

The following preferred embodiments are described using C++ syntax. However, the distributed event notification system can be implemented in most modem computer languages. The Data Sync Server runs as a service that is started and stopped by the server's operating system. Data Sync Clients are created, managed and deleted by client applications and components running on client machines. The notification system of the present invention provides client applications and components with the following Application Programming Interface (MI) functions:
1. Create a Data Sync
2. Delete a Data Sync
3. Attach to a Data Sync
4. Detach from a Data Sync
5. Register interest in object types, specific objects and actions
6. Remove interest in object types
7. Notify the Data Sync of an action performed on objects
8. Handle Data Sync events.

The examples more specifically describe these functions. The following data types are used in the function descriptions in the examples.

TABLE I
DATA TYPES

| DATE TYPE | DESCRIPTION |
|---|---|
| Action | The set of allowable actions performed on objects. The |
| | standard set if actions include: Create, Add, Update, |
| | Delete, Assign and Unassign. Application specific |
| | actions may be defined. |
| DataSyncID | A unique identifier of a Data Sync Service. |
| Destination | Defines the address or location of a machine. The |
| | destination may be specified by machine name, IP |
| | Address or application specific mechanism. |
| EventHandler | An abstraction of an event handler function. |
| GUID | A Globally Unique Identifier that is used to uniquely |
| | identify objects in a distributed system regardless of |
| | where objects are created and when they are created. |
| ObjectType | Defines the type or class of object. |

The following sample application variables are used throughout the examples:

TABLE II
APPLICATION VARIABLES

| VARIABLE | | | DESCRIPTION |
|---|---|---|---|
| DataSyncID | m_DataSyncID; | // | Data Sync Service identifier. |
| Destination | m_Destination; | // | Destination of the server. |
| EventHandler | m_EventHandler; | // | Application event handler. |

The following application specific types are used throughout the examples:

TABLE III
APPLICATION TYPES

| TYPE | DESCRIPTION |
|---|---|
| Patient | A generic patient type that defines a patient. Patients may |
| | have documents assigned and unassigned. |
| Document | A generic document type. |

### EXAMPLE 1

### Creating a Data Sync

Description:

Create a Data Sync Client on the local machine and connect to the Data Sync Server on the specified destination machine.

Create a Data Sync

bool CreateDataSync (Destination destination);
   Return Value:

Returns true if successful otherwise false.

Parameters:

destination The destination of the server the Data Sync Server resides on. A destination may be specified as the name of a machine, an IP Address or application specific address mechanism.

Sample Code:

| | |
|---|---|
| // | |
| // | Create a Data Sync Service. |
| // | |
| if | (!CreateDataSync (m_Destination)) |
| { | |
| | TRACE (“Failed to create a Data Sync Service\n”); |
| | return false; |
| } | |

### EXAMPLE 2

### Deleting a Data Sync

Description:

Delete a Data Sync Service by deleting the local Data Sync Client and removing the association with the Data Sync Server.

Delete a Data Sync

bool DeleteDataSync (DataSyncID &dataSyncID);
   Return Value:

Returns true if successful otherwise false.

Parameters:

dataSyncID A reference to the identifier of the Data Sync Service.

Sample Code:

| | |
|---|---|
| // | |
| // | Delete a Data Sync Service. |
| // | |
| if | (!DeleteDataSync (m_DataSyncID)) |
| { | |
| | TRACE (“Failed to delete the Data Sync |
| | Service\n”); return false; |
| } | |

### EXAMPLE 3

### Attaching to a Data Sync

Description:

Attach the Data Sync Service to an event handler and uniquely identify the service. The Data Sync Service must have been created.

Attach to a Data Sync

bool AttachToDataSync (EventHandler &eventHandler, DataSyncID &dataSyncID));
   Return Value:

Returns true if successful otherwise false.

Parameters:

&eventhandler A reference to the event handler that will handle asynchronous event notifications received by the local Data Sync Service.
&dataSyncID A reference to the identifier of the Data Sync Service the application or component is attached to. The Data Sync Service returns this identifier so the application has a reference to the Data Sync Service. This allows an application or a component to have any number of Data Sync Services and to identify the source of an event.

Sample Code:

| | |
|---|---|
| // | |
| // | Attach to a Data Sync Service. |
| // | |
| if | (!AttachToDataSync, (m_EventHandler, m_DataSyncID)) |
| { | |
| | TRACE (“Failed to attach to the Data Sync Service\n”); |
| | return false; |
| } | |

### EXAMPLE 4

### Detachinq from a Data Sync

Description:

Detach the event handler from the specified Data Sync Service.

Detach From a Data Sync

bool DetachFromDataSync (EventHandler &eventHandler, DataSyncID &dataSyncID));
   Return Value:

Returns true if successful otherwise false.

Parameters:

eventHandler A reference to the event handler.
dataSyncID The Data Sync Service identifier from which to detach.

Sample Code:

| | |
|---|---|
| // | |
| // | Detach from the Data Sync Service. |
| // | |
| if | (!DetachFromDataSync, (m_EventHandler, m_DataSyncID)) |
| { | |
| | TRACE (“Cannot detach from the Data Sync Service\n”); |
| | return false; |
| } | |

### EXAMPLE 5

### Registering an Interest

Description:

Register interest in an object type (such as a database table), specific objects (such as database records) and the actions performed. If the objectlDs set is empty then interest will be registered for all objects of the defined type. If the set of actions is empty then all standard actions will be registered for that object type. Standard actions include: Create, Add, Delete, Update, Assign, and Unassign. Additional application specific application types may be defined.

Register Interest

| | | | |
|---|---|---|---|
| bool | RegisterInterest | ( | DataSyncID dataSyncID, |
| | | | ObjectType objectType, |
| | | | Set<GUID> &objectIDs = Empty, |
| | | | Set<Action> &actions = Empty |
| | | ); | |

Return Value:

Returns true if successful otherwise false.

Parameters:

dataSyncID The identifier of the Data Sync Service in which interest is to be registered.
objectType The object type to be registered.
objectIDs An optional set of specific objects to be registered. Objects are identified by a Globally Unique Identifier (GUID). If the set is empty then all objects of the defined objectType will be registered.
action An optional set of actions to be registered. If the set of actions is empty then all standard actions will be registered.

Sample Code:

| | |
|---|---|
| // | |
| // | Register interest in patient updates for a specific patient. |
| // | |

| | |
|---|---|
| Patient | aPatient. |
| Set<Patient> | patients; |
| Set<Action> | actions; |

| // | Add the patient to the set of patients. |
|---|---|
| patients.insert (aPatient); | |
| // Specify Update actions only. | |
| actions.insert (Update); | |
| if | (!RegisterInterest (m_Datasync, Patient, patients, actions)) |
| { | |
| | Trace (“Cannot register interest in Patient\n”); |
| | return false; |
| } | |

### EXAMPLE 6

### Removing an Interest

Description:

Remove interest in a specified object type from the specified Data Sync Service.

Remove Interest

bool RemoveInterest (DataSyncID dataSyncID, objectType objectType);
   Return Value:

Returns true if successful otherwise false.

Parameters:

dataSyncID The identifier of the Data Sync Service.
objectType The object type to be removed from interest.

Sample Code:

| | |
|---|---|
| // | |
| // | Remove interest in patients. |
| // | |
| If | (!RemoveInterest (m_Datasync, Patient)) |
| { | |
| | Trace (“Cannot remove interest in Patient\n”); |
| | return false; |
| } | |

### EXAMPLE 7

### Notifying Data Sync

Description:

Notify interested parties of a change. Typically, this method is implemented by agents that access the database server, document server and application specific objects.

Notify Data Sync

| | | | |
|---|---|---|---|
| bool | NotifyDataSync | ( | DataSyncID sourceID, |
| | | | ObjectType objectType, |
| | | | Set<GUID> &objectIDs, |
| | | | Action action, |
| | | | ObjectType assignedType = NULL, |
| | | | Set<GUID> &assignedIDs = Empty |
| | | ); | |

Return Value:

Returns true if successful otherwise false.

Parameters:

sourceID The identifier of the source that generated the event.
objectType The type of object that has changed.
objectIDs A set of objects identifiers of the objects that have changed.
action The action performed, e.g. Create, Add, Update, Delete, Assign, Unassign and application specific actions.
assignedType The type of assigned objects. Specifies the type of the objects assigned or unassigned for an Assignment or Unassignment action. May be NULL.
assignedIDs A set of object identifiers of the objects that have been assigned or unassigned. May be empty.

Sample Code:

| | |
|---|---|
| Patient | aPatient; |
| Document | aDocument; |
| Set<Patient> | patients; |

| | |
|---|---|
| // | Add a patient to the set |

patients.insert (aPatient);

| // | | | |
|---|---|---|---|
| // | Notify interested applications of changes to the current patient. | | |
| // | | | |
| if | (patient.Update( )) | | |
| ( | | | |
| | NotifyDataSync | ( | m_DataSyncID, |
| | | | Patient, |
| | | | Patients, |
| | | | Update |
| | | ); | |
| ) | | | |
| // | | | |
| // | Assign a document to a patient and | | |
| // | notify interested applications. | | |
| // | | | |
| if | (patient.Assign (aDocument)) | | |
| { | | | |
| | Set<Document> documents; | | |
| | // Add a document to the set. | | |
| | documents.insert (aDocument); | | |
| | NotifyDataSync | ( | DataSyncID, |
| | | | Patient, |
| | | | patients, |
| | | | Assign, |
| | | | Document, |
| | | | documents) |
| | | ); | |
| } | | | |

### EXAMPLE 8

### Handling Data Sync Events

Description:

The specified event handler for Data Sync Events. This function is asynchronously called from the Data Sync Server.

Data Sync Events

| | | | |
|---|---|---|---|
| void | OnDataSyncEvent | ( | DataSyncID sourceID, |
| | | | ObjectType objectType, |
| | | | Set<GUID> &objectIDs, |
| | | | Action action, |
| | | | ObjectType assignedType = NULL, |
| | | | Set<GUID> &assignedIDs = Empty |
| | | ) | |
| | | ; | |

Return Value:

None.

Parameters:

sourceID The identifier of the source that generated the event.
objectType The type of object that has changed.
objectIDs A set of objects identifiers of objects that have changed.
action The action that caused the change: Create, Add, Update, Delete, Assign, Unassign or application specifications.
assignedType The type of assigned objects. Specifies the type of the objects assigned or unassigned for an Assignment or Unassignment action. May be NULL.
assignedIDs A set of object identifiers of objects that have been assigned or unassigned. May be empty.

Sample Code:

| // | | | |
|---|---|---|---|
| // | An application implements this method to handle data sync | | |
| | events. | | |
| // | This method is called asynchronously. | | |
| // | | | |
| void | Application::OnDataSyncEvent | ( | DataSyncID sourceID, |
| | | | ObjectType objectType, |
| | | | Set<GUID> &objectIDs, |
| | | | Action action, |
| | | | AssignedType assignedType, |
| | | | Set<GULD> &assignedIDs |
| | | ) | |

| | |
|---|---|
| // | |
| // | Test if the event was generated from this application/component. |
| // | |
| if | (sourceID = m_DataSyncID |
| ( | |

```
  // Generated from this application/component.
  return; // Nothing to do.
)
//
```

| | |
|---|---|
| // | Test if there was a change to patients. |
| // | |
| if | (objectType = =Patient) |
| { | |

| | |
|---|---|
| // | |
| // | Test the type of action. |
| // | |
| | If (action = = Create) |
| | { |
| | // Handle creations. |
| | } |
| | else |
| | if (action = = Add) |
| | { |
| | // Handle add objects. |
| | } |
| | else |
| | if (action = = Delete) |
| | { |
| | // Handle deleted objects. |
| | } |
| | else |
| | if (action = = Update) |
| | { |
| | // Handle changed objects. |
| | } |
| | else |
| | if (action = = Assign) |
| | { |
| | // Handle assignments, eg. Patient assign Document. |
| | // Need to process the set of assigned Ids. |
| | } |
| | else |
| | if (action = = Unassign) |
| | } |
| | // Handle unassignments eg. Patient unassign |
| | Document. |
| | // Need to process the set of assigned Ids. |
| | } |
| | else |
| | if (action = = APPLICATION _SPECIFIC) |
| | { |
| | // Handle application specific events. |
| | } |
| | else |
| | { |
| | TRACE (“Invalid action\n”); |
| | } |

```
  }
  else
  if (objectType = = SOME_TYPE_N)
  {
```

// Process the events for SOME_TYPE_N.

}
}

Although embodiments and preferred embodiments of the present invention have been described in the foregoing specification, they are not intended to so limit the invention, the scope of which may include modifications, equivalents and variations not described herein. The true scope and spirit of the invention are embodied in the claims appended hereto.

1. A distributed event notification system comprising:
a server comprising a data synchronization server component;
a client machine comprising a data synchronization client component, and an application; and
a network through which the server and the client machine may communicate,
wherein the data synchronization client component and the data synchronization server component are capable of performing a data synchronization service over the network.

2. The system of claim 1, wherein the application or the component of the client machine is capable of creating, deleting, attaching to, or detaching from the data synchronization service by using the system.

3. The system of claim 1, wherein the application or the component of the client machine is capable of dynamically registering or removing an interest in an object type, a specific object, or an action performed on an object by using the system.

4. The system of claim 3, wherein the application or the component of the client machine is capable of notifying another interested application or component of an action performed on an object type or on a specific object.

5. The system of claim 1 wherein an application or a component is capable of handling an asynchronous event used to notify the application or component of an action performed on an object type or on a specific object.

6. The system of claim 1, wherein the system comprises at least two client machines.

7. The system of claim 1, wherein the client machine comprises at least two different applications.

8. A method of distributing event notifications in a system, said method comprising:
providing a server comprising a data synchronization server component;
providing a plurality of client machines, each comprising a data synchronization client component and an application;
utilizing a network through which the server and the plurality of client machines may communicate;
registering interests associated with objects;
informing the data synchronization client server component of an action performed on an object at a particular one of the plurality of data synchronization client components; and
utilizing the data synchronization server component to notify each of the plurality of data synchronization client components having a registered interest in the object that the action has been performed.

9. The method of distributing event notifications in a system of claim 8, wherein the step of registering interests associated with objects is performed by the server.

10. The method of distributing event notifications in a system of claim 8, wherein the step of registering interests associated with objects is performed by one or more of the plurality of client machines.

11. The method of distributing event notifications in a system of claim 8 further comprising the step of dynamically removing an interest in an object.
